(19) United States
(12) Patent Application Publication
(10) Pub. No.: US 2016/0172987 A1
(43) Pub. Date: Jun. 16, 2016

(54) DC-DC CONVERTER FOR BATTERY SYSTEM WITH WIDE OPERATING VOLTAGE RANGE

(71) Applicant: QUANTUMSCAPE CORPORATION, San Jose, CA (US)

(72) Inventor: Phillip John WEICKER, San Jose, CA (US)

(21) Appl. No.: 14/909,938

(22) PCT Filed: Sep. 2, 2014
(86) PCT No.: PCT/US14/53750

§ 371 Date: Feb. 3, 2016

Related U.S. Application Data
(60) Provisional application No. 61/872,750, filed on Sep. 1, 2013.

(51) Int. Cl. H02M 3/335

(52) U.S. Cl. CPC H02M 3/33546

(57) ABSTRACT

Direct current to direct current (DC-DC) voltage converter apparatuses and methods are provided for a wide voltage range battery cell and operations thereof. The apparatus comprises a first node coupled with a first pole of a battery cell and electrically connected with a first pole of a load device. A second node is coupled with a second pole of the battery cell. A third node electrically connects with a second pole of the load device. A DC-DC voltage converter circuit comprises a primary circuit tied to the first and second nodes, a secondary circuit including a direct conduction path for electrical current to pass from the second to third node, and a galvanically isolated energy transfer path between the primary circuit and the secondary circuit. A voltage output from the secondary circuit adds to (or subtracts from) the battery cell voltage at the second node.

### CROSS-REFERENCES TO RELATED APPLICATIONS

This Application claims the benefit of priority to U.S. Provisional Application No. 61/872,750, filed Sep. 1, 2013, incorporated in its entirety herein for all purposes.

### BACKGROUND

The present invention relates generally to energy storage techniques. In particular, the present invention is related to techniques for incorporating (e.g., into an electric vehicle) a battery cell with a wider voltage range than conventional battery cells. Merely by way of example, the aspects of the invention relate to solid-state battery cells using a conversion cathode chemistry, although there can be other applications.

A rapid increase in the development of communication and transportation devices using batteries for primary energy storage has occurred. As an example, such apparatus include, among others, personal computers, video cameras, portable telephones, and electric and hybrid-electric vehicles. Examples of electric and hybrid automobiles include the Leaf® from Nissan Motor Company and the Prius manufactured by Toyota Motor Corporation, respectively. Although highly successful, these popular apparatus are limited by energy storage capacity and, in particular, battery capacity. Lithium ion batteries with intercalation cathodes and anodes have the highest available energy density currently available.

Many conventional lithium ion batteries utilize a liquid electrolyte containing a flammable organic solvent, generally requiring incorporation of a safety device configured to restrain a rise in electrolyte temperature caused by a short circuit. A lithium ion battery utilizing a solid electrolyte layer has been described to alleviate flammability concerns, thereby reducing or eliminating the need for the safety device. In certain implementations, however, high capacity batteries incorporating solid state materials deliver a wide voltage range dependent on their state of charge. For example, solid state batteries incorporating a conversion cathode material are generally associated with wide output voltage ranges incompatible with the devices they power. Consequently, solid state battery management systems must take such wide voltage ranges into account, in view of both safety and performance considerations.

Direct current to direct current (DC-DC) converters have been incorporated into battery management systems to address incompatibilities between the wide output voltage range of solid state batteries and connected load devices. Conventional DC-DC converters, however, are associated with a number of disadvantages. For example, such converters must generally include components (e.g., semiconductors, capacitors, magnetics, etc.) capable of processing/converting the full power required by the load device. This configuration results in a DC-DC converter characterized by undesirably large size, weight, and cost, and further results in inefficiencies of the overall system.

Improvements in battery technology are sought by the industry.

### SUMMARY

In some embodiments, aspects are related to a direct current DC-DC voltage converter apparatus for a wide voltage range battery cell. The apparatus includes a first node configured to couple with a first pole of a battery cell and configured to electrically connect with a first pole of a load device. A second node is configured to couple with a second pole of the battery cell, and a third node is configured to electrically connect with a second pole of the load device. A DC-DC voltage converter circuit includes a primary circuit including a pair of terminals, a secondary circuit including a pair of terminals and a direct conduction path for electrical current to pass from the second node to the third node, and a galvanically isolated energy transfer path between the primary circuit and the secondary circuit. One terminal of the pair of terminals of the primary circuit is tied to the second node, the other terminal of the pair of terminals of the primary circuit is tied to the first node, one terminal of the pair of terminals of the secondary circuit is tied to the second node, and the other terminal of the pair of terminals of the secondary circuit is tied to the third node, such that a voltage output from the secondary circuit adds to voltage from the battery cell at the second node.

In other embodiments, aspects are related to a DC-DC voltage converter apparatus for a wide voltage range battery cell. The apparatus includes a first node configured to couple with a first pole of a battery cell and configured to electrically connect with a first pole of a load device. A second node is configured to couple with a second pole of the battery cell, and a third node is configured to electrically connect with a second pole of the load device. A DC-DC voltage converter circuit includes a primary circuit comprising a pair of terminals, a secondary circuit comprising a pair of terminals and a direct conduction path for electrical current to pass from the second node to the third node, and a galvanically isolated energy transfer path between the primary circuit and the secondary circuit. One terminal of the pair of terminals of the primary circuit is tied to the second node, the other terminal of the pair of terminals of the primary circuit is tied to the first node, one terminal of the pair of terminals of the secondary circuit is tied to the second node, and the other terminal of the pair of terminals of the secondary circuit is tied to the third node, such that a voltage output from the secondary circuit subtracts from voltage from the battery cell at the second node.

In other embodiments, aspects are related to a method of regulating DC current from a battery cell. The method includes allowing current from a first pole of a battery cell to flow in a direct conduction path through a circuit into a load device. A battery cell input voltage and an output voltage to the load device are sensed during the current flow. A DC-DC converter is activated from the battery cell based on the sensing. A voltage produced from the DC-DC converter is additively combined to voltage from the battery cell during the current flow, the combined voltage powering the load device.

In other embodiments, aspects are related to a method of regulating DC current from a battery cell. The method includes allowing current from a first pole of a battery cell to flow in a direct conduction path through a circuit into a load device. A battery cell input voltage and an output voltage to the load device are sensed during the current flow. A DC-DC converter is activated from the battery cell based on the sensing. A voltage produced from the DC-DC converter is subtracted from voltage from the battery cell during the current flow, the reduced voltage powering the load device.

### BRIEF DESCRIPTION OF THE DRAWINGS

FIG. 1 illustrates a simplified block diagram of a system including a DC-DC voltage converter apparatus, in accordance with some embodiments of the invention.

FIG. 2 illustrates a schematic circuit diagram including a DC-DC voltage converter apparatus, in accordance with some embodiments of the invention.

FIG. 3A illustrates a schematic circuit diagram of a primary circuit included in a DC-DC voltage converter apparatus, in accordance with some embodiments of the invention.

FIG. 3B illustrates a schematic circuit diagram of a secondary circuit included in a DC-DC voltage converter apparatus, in accordance with some embodiments of the invention.

FIG. 4 illustrates a simplified cross section of a transformer that can provide a galvanically isolated energy transfer path between a primary circuit and a secondary circuit in a DC-DC voltage converter apparatus, in accordance with some embodiments of the invention.

FIG. 5 illustrates exemplary voltage and current waveforms in a DC-DC voltage converter apparatus resulting from activation of switching devices, in accordance with some embodiments of the invention.

FIGS. 6A and 6B illustrate exemplary diagrams of voltage versus state of charge of a battery cell incorporating a DC-DC voltage converter apparatus, in accordance with some embodiments of the invention.

FIG. 7 illustrates a schematic circuit diagram including a DC-DC voltage converter apparatus utilizing a polyphase transformer, in accordance with some embodiments of the invention.

FIG. 8 illustrates an exemplary flowchart of a method of regulating DC current from a battery cell, in accordance with some embodiments of the invention.

### DETAILED DESCRIPTION

### I. General

The disclosure herein provides apparatuses and methods for regulating a wide output voltage range of a battery cell (e.g., a solid state battery cell). A DC-DC converter apparatus can include a first node coupled with a first pole of a battery cell and electrically connected with a first pole of a load device, a second node coupled with a second pole of the battery cell, and a third node electrically connected with a second pole of the load device. A DC-DC voltage converter circuit can include a primary circuit tied to the first and second nodes, a secondary circuit including a direct conduction path for electrical current to pass from the second to third node, and a galvanically isolated energy transfer path between the primary circuit and the secondary circuit.

A voltage output from the secondary circuit can add to the battery cell voltage at the second node. In some embodiments, the voltage output from the secondary circuit can subtract from the battery cell voltage at the second node.

As a non-limiting illustration, the primary circuit can include an H bridge inverter circuit having transistor switching devices, and the secondary circuit can include diodes configured in a full bridge rectifier. The primary circuit and secondary circuit can be galvanically isolated using a transformer, such that the primary circuit includes a primary winding of the transformer and the secondary circuit includes a secondary winding of the transformer, the primary and secondary windings being magnetically coupled via an iron core.

In this illustration, the battery cell can include a plurality of cells having a string voltage range of 150 V to 450 V depending on the state of charge, the battery cells being electrically connected to a load device having a voltage requirement of 300 V to 450 V. The DC-DC converter apparatus can include a voltage sensor configured to measure the voltage between the first and third nodes, the first node coupled with the first pole of the battery cell and electrically connected to the load device, and the third node electrically connected with the second terminal of the load device. If the detected voltage falls below the minimum of 300 V required by the load device, a control circuit can activate the switching devices of the H bridge inverter in the primary circuit. In response, a time varying current waveform can be generated in the primary winding of the transformer.

Due to the magnetic coupling, corresponding time varying voltage and current waveforms can be generated in the secondary coil of the transformer, the secondary coil being coupled to the secondary circuit. The signal can be rectified by the full bridge rectifier diodes in the secondary circuit, and the resulting voltage added to the voltage from the battery cell at the second node. In this configuration, the output of the DC-DC voltage converter circuit is in series with the battery cell, such that the load device is powered by the combined voltage of the battery cell and the converter output. The switching frequency and duty cycle can be optimized by the control circuit to contribute the precise amount of voltage to the battery cell voltage output to match that required by the load device. For example, if the battery string voltage drops to 299 V as a result of its state of charge, the selected switching frequency and duty cycle may result in the DC-DC voltage converter generating 1 V which, when added to the battery string voltage, provides the load device with its minimum required voltage of 300 V.

Technical advantages of some embodiments include that the primary and secondary circuits of the DC-DC voltage converter need only be capable of converting the power fraction being added to that provided by the battery cell (e.g., the product of the load current multiplied by 1 V in this illustration). The output of the secondary circuit and the battery cell can be connected in series with the combination of the voltage component provided by the converter and the voltage component provided by battery cell being delivered to the load device. Since only a fraction of the overall power provided to the load device flows through the DC-DC converter, its components (e.g., semiconductors, capacitors, magnetics, etc.) can be scaled down, thereby reducing the size, weight, cost, and overall inefficiencies of the system while still matching the output voltage with that required by the load device. Moreover, when the battery cell has a state of charge sufficient to power the load device such that no additional voltage from the DC-DC converter is needed, electrical current can flow from the battery cell to the load device in a direct conduction path with minimal voltage loss. For example, in the above illustration, the current can flow from the battery cell to the load device through diodes of the rectifier circuit, such diodes being associated with a small voltage drop.

In some embodiments, voltage can also be subtracted from that provided by the battery cell. For example, in the above illustration, the diodes in the full bridge rectifier of the secondary circuit can be replaced with switching elements similar to those in the primary circuit. When the voltage sensor determines that the battery voltage measured between the first and third nodes exceeds the maximum required by the load device, the control circuit can activate the switching devices of the secondary circuit, thereby generating a time varying current waveform in the secondary winding of the transformer. The corresponding current induced in the primary winding can be rectified by activating the switching devices in the primary circuit to act as synchronous rectifiers. Since the output of the secondary circuit is in series with the battery cell, the combined voltage at the second node and provided to the load device can be equal to the voltage of the battery cell reduced by the absolute value of the negative voltage provided by secondary circuit of the DC-DC converter.

### II. Definitions

“Direct conduction path” refers to a path in an electrical system across which current can flow directly.

“Galvanically isolated energy transfer path” refers to a path in an electrical system across which no current can flow directly. Electrical energy can instead be exchanged across a galvanically isolated energy transfer path by way of capacitance, induction, or electromagnetic waves. Galvanically isolated energy transfer paths useful in the present invention may include any suitable electrical components including, but not limited to, transformers.

“H bridge inverter circuit” refers to an electrical circuit configured to generate a voltage output across a load with both positive and negative components by converting a direct current (DC) signal into an alternating current (AC) signal. H bridge inverter circuits useful in the present invention may utilize four switching devices. As used herein, however, an “H bridge inverter circuit” useful in the present invention may utilize any suitable number of switching devices, including 6, 8, 10, . . . N. Exemplary switching devices may include, but are not limited to, transistors (e.g., MOSFET (metal-oxide semiconductor field-effect transistor), IGBT (insulated-gate bipolar transistor), and the like), mechanical switches, and the like. An H bridge inverter circuit may be a single-phase inverter circuit, and may further be a polyphase inverter circuit producing an output voltage having three or more phases.

“Full bridge rectifier” refers to an electrical circuit configured to convert an AC signal into a DC signal, such that the whole of the input waveform is converted into a waveform of constant polarity (i.e. positive or negative) at its output. A full bridge rectifier useful in the present invention may utilize four diodes in a bridge configuration and coupled to an AC source (e.g., a winding of a transformer). As used herein, however, a “full bridge rectifier” useful in the present invention may utilize any suitable number of diodes, including 6, 8, 10, . . . N.

“Transformer” refers to an electrical device configured to transfer electrical energy through electromagnetic induction. A transformer may include a magnetic core material, two or more windings, and an insulator material separating the windings. Transformers useful in the present invention include any suitable magnetic core materials, insulator materials, and number of windings. Exemplary magnetic core materials include, but are not limited to, Fe—Si alloy, carbonyl iron, air, and the like. Exemplary insulator materials include, but are not limited to, polyimide, polyester, oxides, nitrides, ceramics, and the like. Transformers useful in the present invention may be single-phase transformers incorporating two windings (i.e. a primary and secondary winding), and may further include polyphase transformers incorporating three or more pairs of corresponding primary and secondary windings.

“About,” when used to describe a voltage value or voltage range values, refers to +/−10% of the specified voltage value or voltage range values.

### III. DC-DC Voltage Converter Apparatus

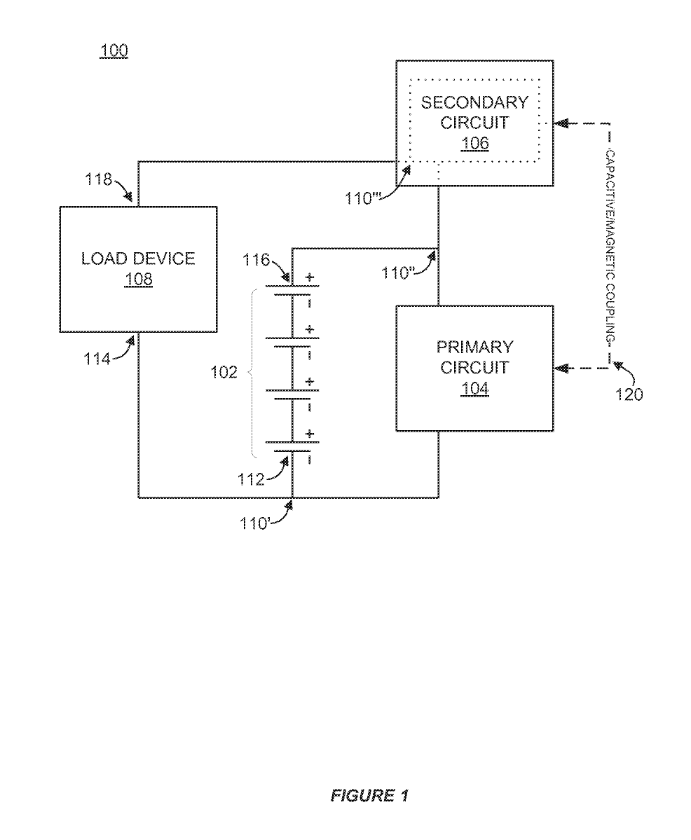

FIG. 1 illustrates a simplified block diagram of a system 100 including a DC-DC voltage converter apparatus, in accordance with some embodiments of the invention. As seen in FIG. 1, the system 100 may include a battery cell 102, a DC-DC converter circuit including a primary circuit 104 and a secondary circuit 106, and a load device 108. As described herein with reference to FIGS. 1-8, in some embodiments, a “battery cell” (e.g., battery cell 102) can include a series-connected string of a plurality of battery cells.

The system 100 may include a first node 110′ configured to couple with a first pole 112 of the battery cell 102 and configured to electrically connect with a first pole 114 of the load device 108. A second node 110″ may be configured to couple with a second pole 116 of the battery cell 102. The system 100 may further include a third node 110′″ configured to electrically connect with a second pole 118 of the load device 108. As illustrated in FIG. 1, the secondary circuit 106 may include a direct conduction path for electrical current to pass from the second node 110″ to the third node 110′″. The DC-DC converter circuit may further include a galvanically isolated energy transfer path 120 between the primary circuit 104 and the secondary circuit 106. In some embodiments, as described in further detail below, the galvanically isolated energy transfer path 120 may magnetically couple the primary circuit 104 and the secondary circuit 106 by way of, for example, a transformer including a primary winding coupled to the primary circuit 104 and a secondary winding coupled to the secondary circuit 106.

As illustrated in FIG. 1, the secondary circuit 106 and the battery cell 102 may be connected in series. As a result, voltage produced in the secondary circuit 106 can be added to the voltage produced by the battery cell 102, with the combined voltage being delivered to the load device 108.

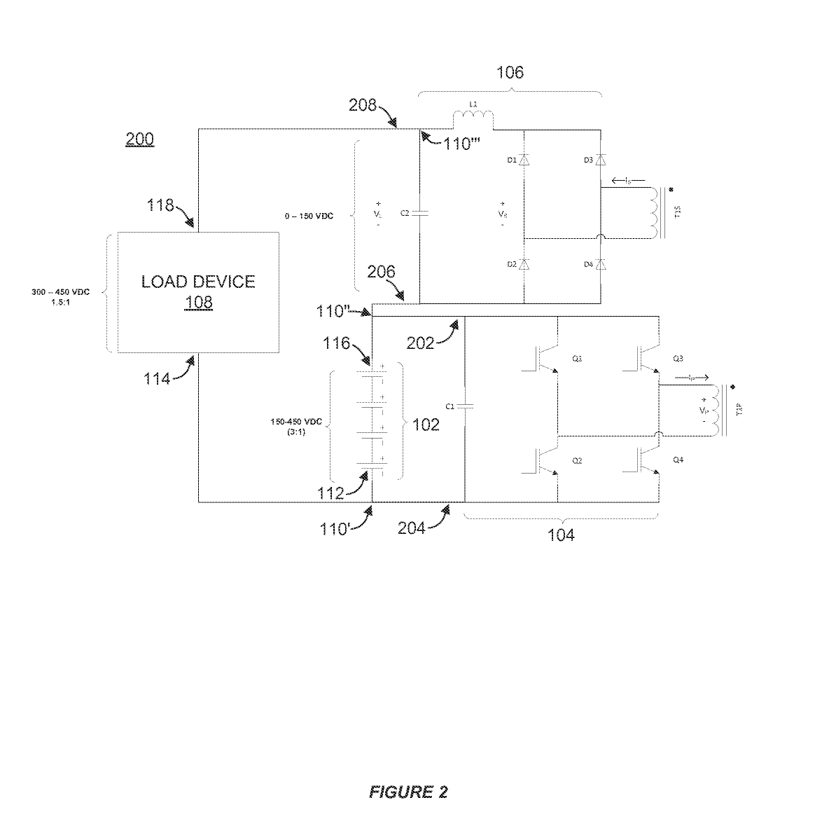

In embodiments of the invention, the primary circuit 104 and secondary circuit 106 may include any suitable circuit configurations and any suitable combination of electrical components. An exemplary configuration is shown in FIG. 2 which illustrates a schematic circuit diagram 200 including a DC-DC voltage converter apparatus, in accordance with some embodiments of the invention.

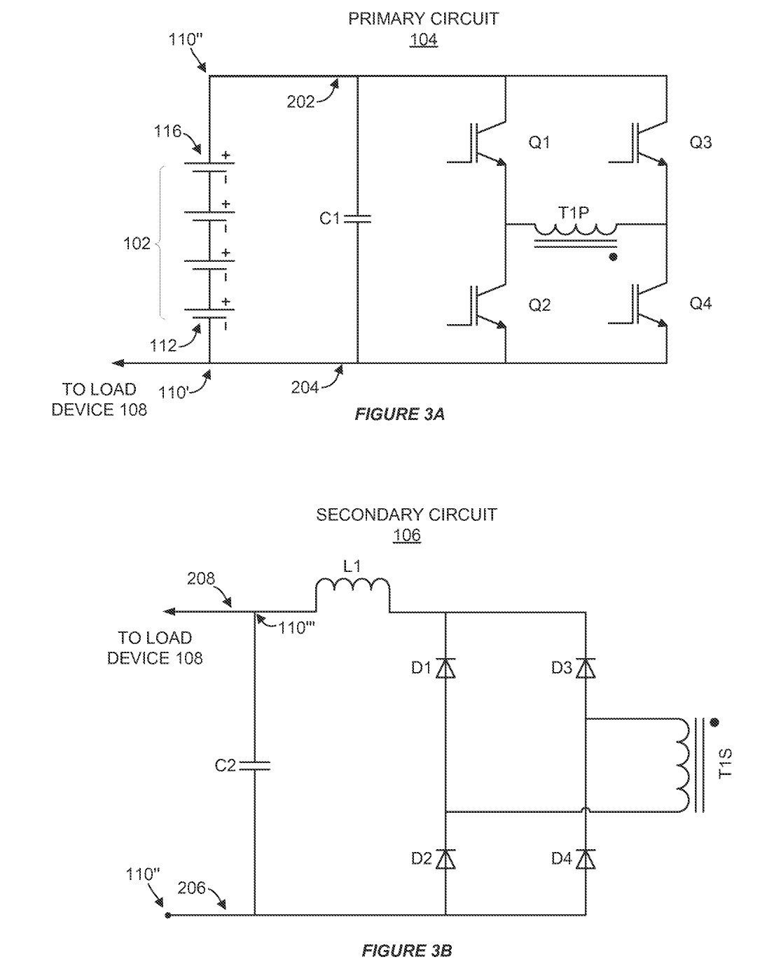

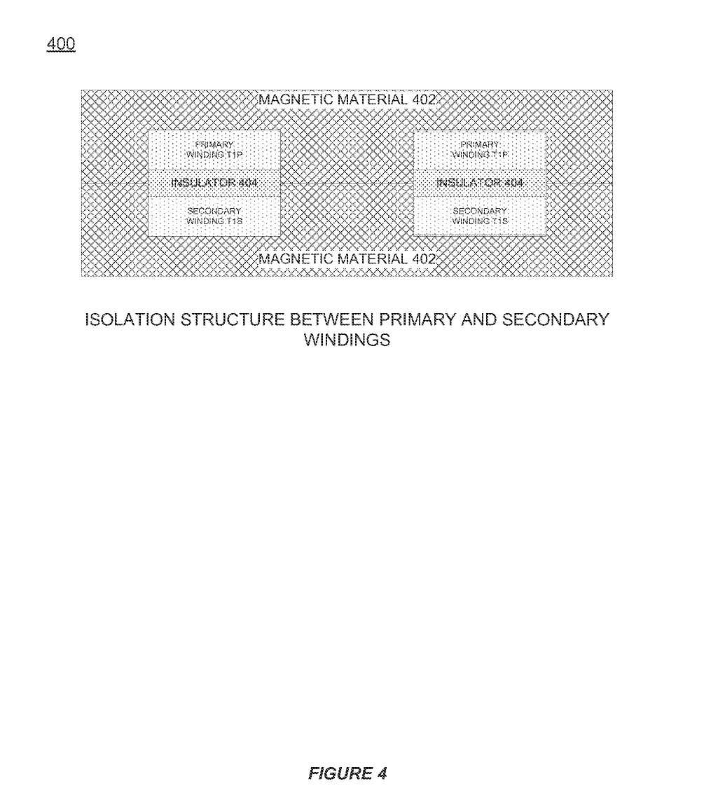

As with FIG. 1, the DC-DC converter apparatus illustrated in FIG. 2 can include the first node 110′ configured to couple with the first pole 112 of the battery cell 102 and configured to electrically connect with the first pole 114 of the load device 108, the second node 110″ configured to couple with the second pole 116 of the battery cell 102, and the third node 110′″ configured to electrically connect with the second pole 118 of the load device 108. The DC-DC converter circuit includes the primary circuit 104 including a pair of terminals 202, 204, the secondary circuit 106 including a pair of terminals 206, 208 and a direct conduction path for electrical current to pass from the second node 110″ to the third node 110′″, and a galvanically isolated energy transfer path between the primary circuit 104 to the secondary circuit 106. The primary circuit 104 and secondary circuit 106 are further illustrated in FIGS. 3A and 3B, respectively.

In some embodiments, as illustrated in FIG. 2, one terminal 202 of the pair of terminals of the primary circuit 104 can be tied to the second node 110″, the other terminal 204 of the pair of terminals of the primary circuit 104 can be tied to the first node 110′, one terminal 206 of the pair of terminals of the secondary circuit 106 may be tied to the second node 110″, and the other terminal 208 of the pair of terminals of the secondary circuit 106 may be tied to the third node 110′″, such that a voltage output from the secondary circuit 106 adds to voltage from the battery cell 102 at the second node 110″.

In some embodiments the primary circuit 104 can include switching devices. Such switching devices may be included in a H bridge inverter circuit. For example, as illustrated in FIG. 2 and FIG. 3A, the primary circuit 104 can include an H bridge inverter circuit including switching devices Q1, Q2, Q3, and Q4 which may be any suitable type of switching devices including, but not limited to, transistors (e.g., MOSFET, IGBT devices, and the like), mechanical switches, and the like. The primary circuit 104 may further include a capacitor C1 in parallel with terminals 202, 204.

In some embodiments, the secondary circuit 106 can include diodes configured in a full bridge rectifier. For example, as illustrated in FIG. 2 and FIG. 3B, the secondary circuit 106 can include a full bridge rectifier including diodes D1, D2, D3, and D4 which can be any suitable type of solid state (e.g., semiconductor) diode devices. The secondary circuit 106 may further include one or more inductors (e.g., inductor L1) in series with terminal 208 and one or more capacitors (e.g., capacitor C2) in parallel with terminals 206, 208. Such inductors and capacitors may be used in the secondary circuit 106 to filter signals rectified by the diodes D1-D4 in some embodiments. As described in further detail below, in some embodiments, the diodes D1-D4 can be replaced with switching devices such as MOSFETs or IGBTs driven by an appropriate control circuit in a synchronous rectifier configuration.

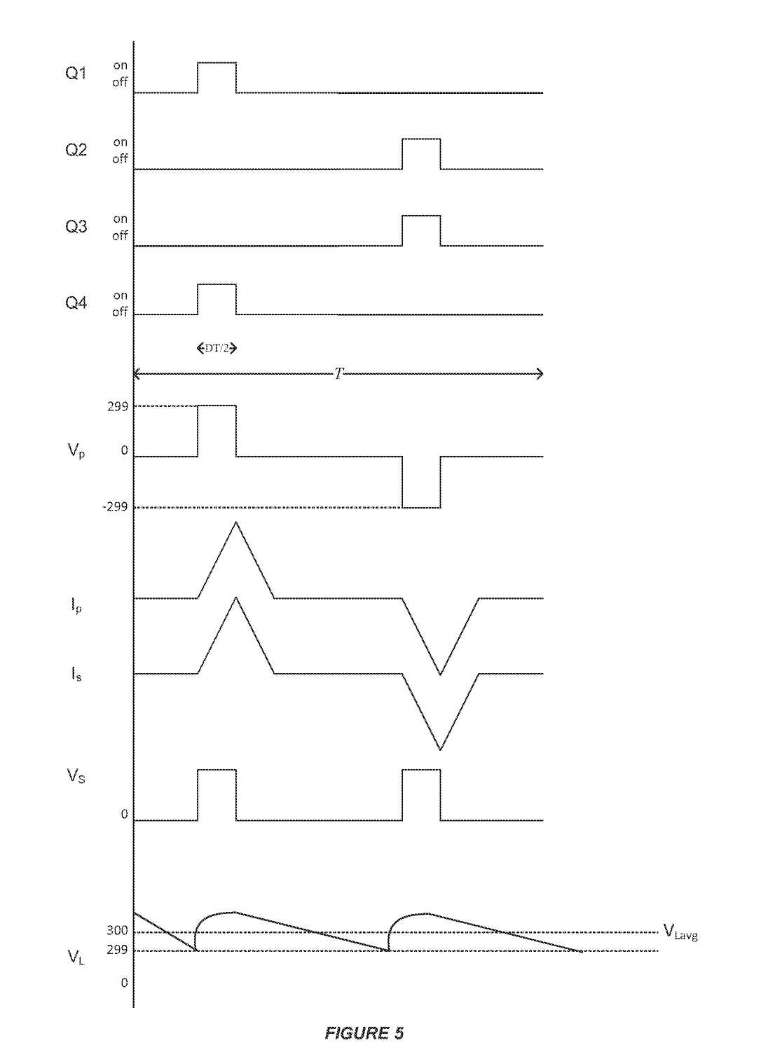

As described above, the DC-DC voltage converter circuit can include a galvanically isolated energy transfer path between the primary circuit 104 and the secondary circuit 106. In some embodiments, the galvanically isolated energy transfer path can include a transformer. For example, as illustrated in FIGS. 2-3B, the switching devices Q1-Q4 of the primary circuit 104 can be coupled to a primary winding T1P of a transformer, and the secondary circuit 106 can be coupled to a secondary winding T1S of the transformer. An exemplary transformer according to some embodiments of the invention is shown in FIG. 4.

FIG. 4 illustrates a simplified cross section of a transformer 400 that can provide a galvanically isolated energy transfer path between a primary circuit and a secondary circuit in a DC-DC voltage converter apparatus, in accordance with some embodiments. As seen in FIG. 4, the transformer may include the primary winding T1P and the secondary winding

T1S galvanically separated by an insulator 404. As described above, the primary winding T1P can be coupled to switching devices (e.g., Q1-Q4) of the primary circuit 104, and the secondary winding T1S can be coupled to the secondary circuit 106. The insulator 404 may be comprised of any suitable dielectric material. In some embodiments, dielectric material can include a polyimide, polyester, or the like. Such materials may provide galvanic isolation at temperatures up to about 150° C. In some embodiments, the dielectric material can include an oxide material, nitride material, ceramic material, or the like. Such materials may provide galvanic isolation at higher temperatures up to about 600° C. The dielectric material of the galvanically isolated energy transfer path may be characterized by a breakdown voltage of about 500 V to 8 kV, 525 V to 7 kV, or 550 V to 6 kV. In some embodiments, the dielectric material of the galvanically isolated energy transfer path can be characterized by a breakdown voltage of about 600 V to 5 kV.

As further illustrated in FIG. 4, the transformer 400 may further include a core comprised of a magnetic material 402. Any suitable magnetic core material can be used in the transformer 400. For example, as illustrated in FIGS. 2-3B, a magnetic core comprising

Fe (iron) may be used. Other exemplary transformer core materials can include, but are not limited to, Fe—Si alloy, carbonyl iron, air, and the like.

Referring back to FIGS. 2-3B, in some embodiments, the DC-DC voltage converter apparatus can further include a voltage sensor (not shown) configured to measure a voltage between the first and third nodes 110′, 110′″, and a control circuit (not shown) configured to activate the switching devices Q1-Q4 based on the measured voltage between the first and third nodes 110′, 110′″. Further, an optional voltage sensor (not shown) may be configured to measure a voltage between the second and third nodes 110″, 110′″, and the control circuit may be optionally configured to activate the switching devices Q1-Q4 based on the voltage measured between the second and third nodes 110″, 110′″.

By measuring the voltage between the first and third nodes 110′, 110′″ and/or between the second and third nodes 110″, 110′″, the string voltage provided by the battery cell 102 can be determined. This battery voltage can be compared to that required by the load device 108. For example, in the illustration described above, the load device 108 may have a voltage requirement of 300 V to 450 V, with the battery cell 102 having a string voltage range of 150 V to 450 V depending on the state of charge of the battery cell 102. If the voltage measured by the sensor is below that required by the load device 108 (e.g., below 300 V), the control circuit may in response activate the switching devices Q1-Q4.

Since the switching devices Q1-Q4 can be coupled to the primary winding T1P of the transformer, the activation of the switching devices Q1-Q4 may result in electrical current flowing from the battery cell 102 through the primary winding T1P. By utilizing the appropriate switching frequency and duty cycle, the switching devices Q1-Q4 may be configured to generate a time varying current waveform in the primary winding T1P. A corresponding second time varying current waveform can be induced in the secondary winding T1S of the transformer. The secondary circuit 106, which may be coupled to the secondary winding T1S, can rectify the second time varying current waveform to convert the waveform into a DC output. For example, as illustrated in FIG. 2, the time varying current waveform induced in the secondary winding T1S can be rectified by the diodes D1-D4. In some embodiments, the rectified signal may be filtered by one or more inductors or capacitors (e.g., L1, C2).

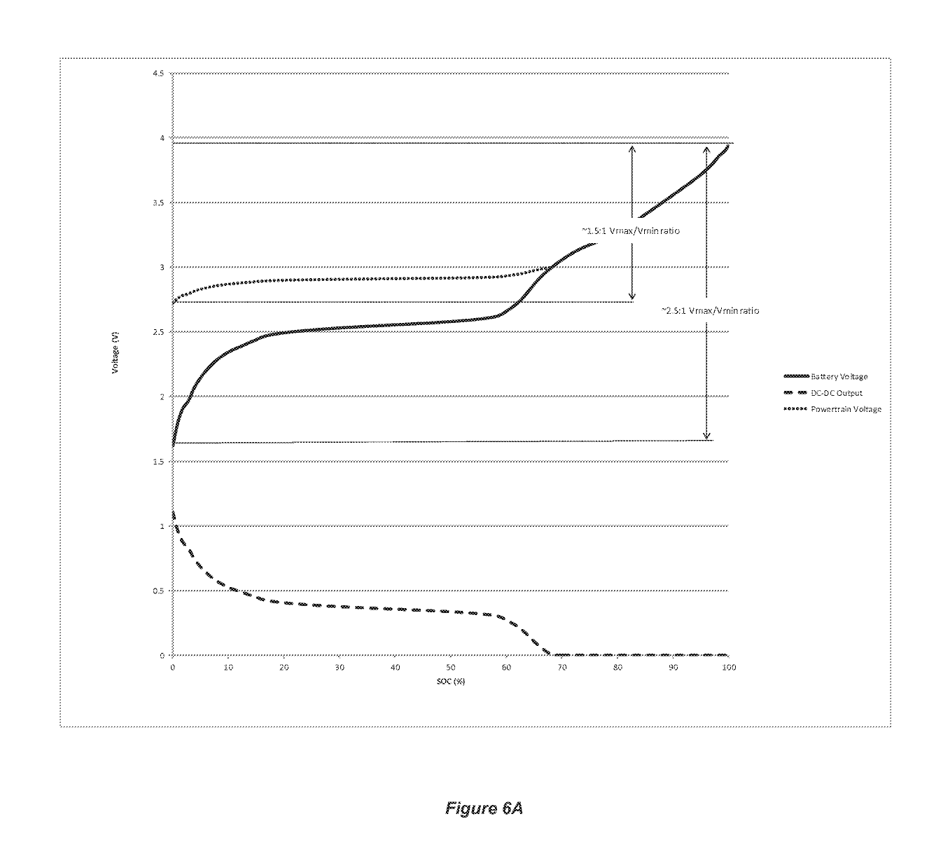

FIG. 5 illustrates exemplary voltage and current waveforms in a DC-DC voltage converter apparatus resulting from activation of switching devices, in accordance with some embodiments. As described above, switching frequency and duty cycle can be optimized such that the current induced in the secondary circuit 106 results in a rectified voltage output that, when added to the voltage provided by the battery cell 102 at the second node 110″, provides the desired combined voltage to the load device 108.

With reference to FIGS. 2 and 5, the switching devices Q1-Q4 of the H bridge inverter circuit in the primary circuit 104 can be activated (i.e. closed) in a sequential pattern to generate a time varying current waveform, and thus a time varying voltage V_{P}, in the primary winding of the transformer. For example, as shown in FIG. 5, switching devices Q1 and Q4 can be activated to generate a positive voltage square wave pulse across the transformer primary winding T1P, and switching devices Q2 and Q3 can be activated to generate a negative voltage square wave pulse across the same, thereby creating a time varying voltage V_{P} in the primary winding of the transformer. The waveform of the time varying current I_{P} is generated in the primary winding T1P, and the corresponding time varying current I_{S} is magnetically induced in the secondary winding T1S coupled to the secondary circuit 106, are illustrated in FIG. 5. The induced signal can be rectified by diodes D1-D4 of the full bridge rectifier included in the secondary circuit 106, such that any negative voltage pulses are converted into positive voltage pulses, thereby producing a DC output that, although pulsed, is of a single polarity. The rectified voltage is indicated by V_{S} in FIGS. 2 and 5. As illustrated in FIG. 2, the rectified signal can be filtered by the inductor L1 and capacitor C2, with the filtered output voltage from the secondary circuit 106 being represented by V_{L}. An exemplary waveform of the rectified and filtered voltage V_{L} provided to the load device 108 is shown in FIG. 5. In the example shown in FIG. 5, the battery cell 102 provides an output voltage of 299 V to the load device 108 that may require a minimum voltage of 300 V. Accordingly, in this example, the DC-DC converter can provide 1 V to the 299 V voltage provided by the battery cell 102, thereby providing a combined voltage of 300 V suitable to power the load device 108.

In a converter configuration such as that described herein utilizing an H bridge inverter circuit and a full bridge rectifier, the average voltage output of the converter (i.e. V_{Lavg} shown in FIG. 5) may be directly proportional to the duty cycle (i.e. the fraction of time that a given switch is closed). By optimizing the duty cycle and switching frequency, the DC-DC voltage converter may contribute the precise amount of additional voltage needed to power the connected load device 108.

The DC output provided by the DC-DC voltage converter may produce a voltage between the second node 110″ and the third node 110′″. As illustrated in FIG. 2, this voltage is provided in series with the voltage provided by the battery cell 102. Accordingly, the voltage provided by the secondary circuit 106 can be added to the voltage of the battery cell 102 at the second node 110″, with the combined voltage being provided to the load device 108. In some embodiments, the voltage added by the galvanically isolated energy transfer path to the voltage from the battery cell 102 at the second node 110″ can be about 0 V to 500 V, 0 V to 450 V, 0 V to 400 V, 0 V to 350 V, 0 V to 300 V, 0 V to 250 V, or 0 V to 200 V. In some embodiments, the voltage added by the galvanically isolated energy transfer path to the voltage from the battery cell 102 can be about 0 V to 150 V. Further, as described herein, the DC-DC voltage converter apparatus may be configured to subtract voltage from that provided by the battery cell 102. Accordingly, the exemplary voltages described above can be negative voltage values such that the combined voltage provided to the load device 108 is less than that provided by the battery cell 102 alone.

The voltage converter circuit may be configured for a battery string voltage range from about 150 V to 450 V, and may be characterized by an output voltage range from about 300 V to 450 V, in some embodiments. In some other embodiments, the voltage converter circuit may be configured for a battery string voltage range from about 250 V to about 750 V, and may be characterized by an output voltage range from about 500 V to 700 V or from about 600 V to 800 V. The voltage converter circuit may also be configured for a battery string voltage less than 150 V and/or greater than 750 V, and may also be characterized by an output voltage less than 300 V and/or greater than 800 V, according to some other embodiments of the invention.

The voltage converter circuit may be characterized by an output power range from about 50 kW to 1 GW, 60 kW to 900 kW, 70 kW to 800 kW, 80 kW to 700 kW, or 90 kW to 600 kW peak power. In some embodiments, the voltage converter circuit may be characterized by an output power range from about 100 kW to 500 kW peak power.

The voltage converter circuit may be characterized by a switching frequency of about 1 kHz to 1 GHz, 2 kHz to 850 kHz, 3 kHz to 700 kHz, or 4 kHz to 550 kHz. In some embodiments, the voltage converter circuit may be characterized by a switching frequency of about 5 kHz to 500 kHz.

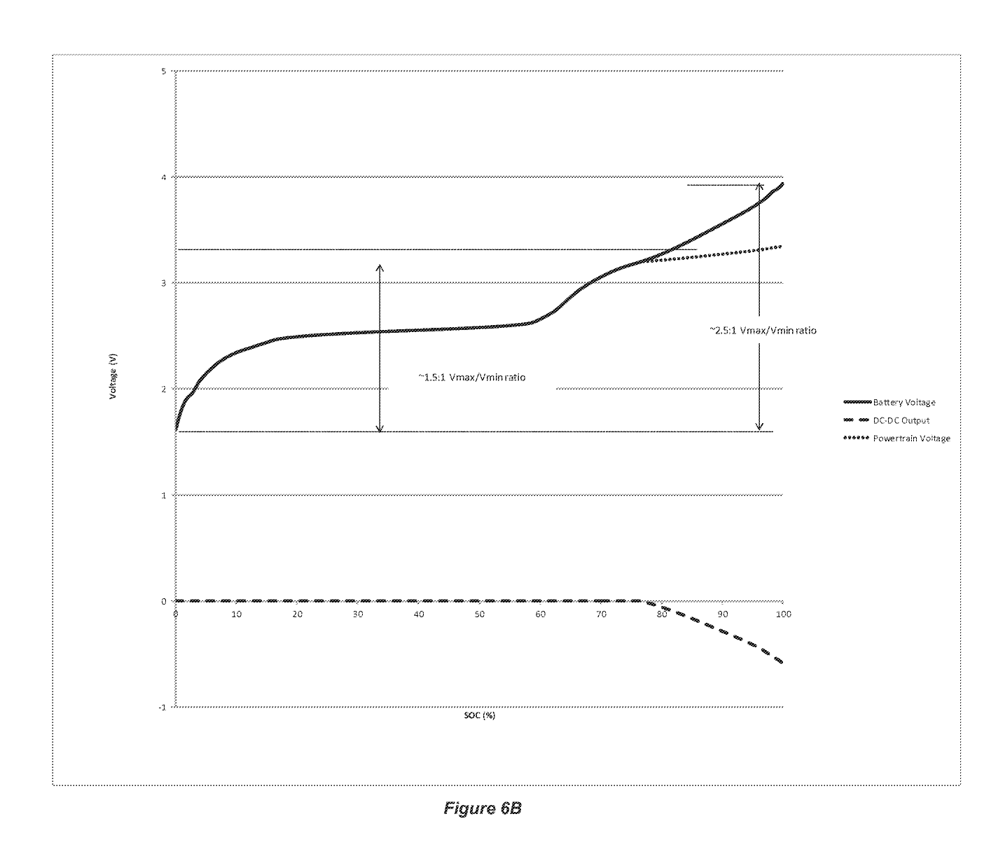

FIGS. 6A and 6B illustrate exemplary diagrams of voltage versus state of charge “SOC (%)” of a battery cell incorporating a DC-DC voltage converter apparatus, in accordance with some embodiments of the invention. In the example shown in FIG. 6A, a battery chemistry is utilized having two voltage plateaus during discharge at approximately 2.5 V and 3.3 V, but with an output voltage range across the operating state of charge from approximately 1.5 V to 4.0 V. A DC-DC voltage converter apparatus, according to embodiments of the present invention, generates a positive output voltage which is added to the battery cell voltage when below approximately 70% state of charge, the combined voltage (i.e. “Powertrain Voltage” in FIG. 6A) being provided to a connected load device. As a result, the voltage range provided to the load device is narrowed to approximately 2.7 V to 4.0 V per cell as compared to the inherent battery cell voltage range of approximately 1.5 V to 4.0 V per cell. Thus, in this example, the ratio of maximum to minimum voltages provided to the load device is reduced from approximately 2.5:1 to 1.5:1. When the state of charge of the battery cell is at or greater than approximately 70%, in this example, the DC-DC converter does not generate or contribute additional voltage.

As described above, in some embodiments, the DC-DC voltage converter apparatus can subtract from the voltage provided by the battery cell, thereby reducing the voltage provided to a connected load device. FIG. 6B illustrates an example of such a voltage subtraction. In this example, when the state of charge of the battery cell is greater than about 75%, the DC-DC converter can generate a negative output voltage which, when combined with the battery cell voltage, results in a lower voltage being provided to the load device than that generated by the battery cell. Specifically, in this example, the voltage range provided to the load device is narrowed to approximately 1.5 V to 3.3 V per cell as compared to the inherent battery cell voltage range of approximately 1.5 V to 4.0 V per cell. Accordingly, the ratio of maximum to minimum voltages provided to the load device is reduced from approximately 2.5:1 to 1.5:1.

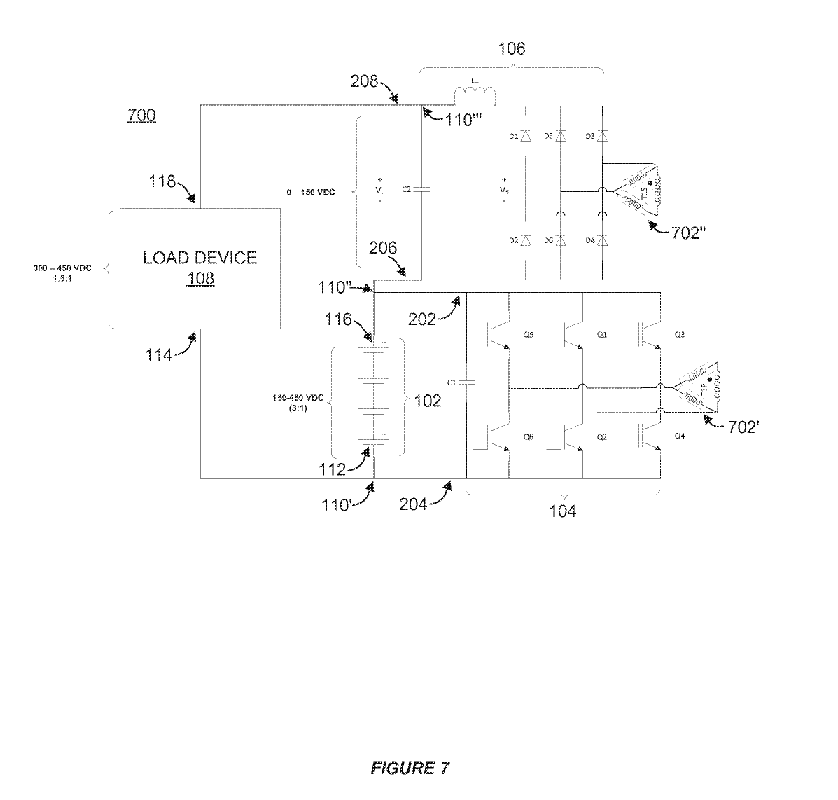

As illustrated in FIGS. 2-3B, a transformer with one primary winding T1P and one secondary winding T1S can be utilized, such that the switching devices Q1-Q4 of the primary circuit 104 can be coupled to the primary winding T1P, and the secondary circuit 106 can be coupled to the secondary winding T1S. Embodiments of the invention further encompass transformers utilizing more than one pair of magnetically coupled windings. For example, in some embodiments, the primary circuit 104 may include a polyphase inverter circuit, the secondary circuit 106 may include a polyphase rectifier, and/or the galvanically isolated energy transfer path may include a polyphase transformer. Such a configuration is shown in FIG. 7 which illustrates a schematic circuit diagram 700 including a DC-DC voltage converter apparatus utilizing a polyphase configuration, in accordance with some embodiments of the invention. In particular, in FIG. 7, a triphase transformer (in a Wye configuration), inverter circuit, and rectifier circuit are illustrated. The circuit diagram 700 is similar to the circuit diagram 200 described above with respect to FIGS. 2-3B, and thus the features and capabilities described above for the circuit diagram 200 also apply to the circuit diagram 700. As illustrated in FIG. 7, the schematic circuit diagram 700 can include a number of additional components, such as three primary windings 702′ of a triphase transformer coupled to the primary circuit 104 and three secondary windings 702″ of the triphase transformer coupled to the secondary circuit 106. The primary circuit 104 in the illustrated configuration further includes switching devices Q5 and Q6 which, in combination with switching devices Q1-Q4, can form a triphase inverter circuit, and secondary circuit 106 can further include diodes D5 and D6 which, in combination with diodes D1-D4, can form a triphase rectifier circuit. Although a triphase configuration is illustrated, this is not intended to be limiting. In embodiments of the invention, a polyphase DC-DC voltage converter can be configured for any suitable number of phases (e.g., 4, 5, 6, . . . N phases).

A polyphase voltage converter configuration may provide a number of additional advantages. For example, due to overlapping waveforms induced across the galvanically isolated energy transfer path, magnetic material in the transformer core can be more effectively used, higher effective switching frequencies can be achieved, secondary ripple current can be lower, and the overall efficiency of the DC-DC voltage converter apparatus can be increased.

The combination of the full bridge rectifier and H bridge inverter circuits illustrated in FIGS. 2-3B and 7 is not intended to be limiting, as embodiments of the invention may encompass any suitable circuit configurations and any suitable combinations of electrical components. For example, the primary circuit 104 can include a first H bridge inverter circuit and the secondary circuit 106 can include a second H bridge inverter circuit. This configuration may be accomplished by replacing the diodes D1-D4 of the secondary circuit 106 (illustrated in FIGS. 2 and 3B) with switching devices, which can be any suitable type of switching devices including, but not limited to, transistors (e.g., MOSFET, IGBT, and the like), mechanical switches, and the like. Similarly, in the triphase configuration illustrated in FIG. 7, the diodes D1-D6 can be replaced with such switching devices. The asynchronous rectification resulting from replacing a full bridge rectifier with an H bridge inverter circuit can provide a number of additional advantages. Since switching devices are generally associated with lower losses than diodes, the resulting voltage converter apparatus can have improved efficiency. Moreover, the dual-H bridge configuration may provide bi-directional functionality such that energy can also be transferred from the secondary circuit 106 to the primary circuit 104.

As described above, when the battery cell 102 has a state of charge sufficient to power the load device such that no additional voltage from the DC-DC converter is needed, electrical current can flow from the battery cell 102 to the load device 108 in a direct conduction path with minimal voltage loss. For example, as illustrated in FIG. 2, electrical current can pass from the second node 110″ coupled with the second pole 116 of the battery cell 102 across diodes D1, D2 and inductor L1 to the third node 110′″. The electrical current can flow from the second node 110″ to the third node 110′″ following the same path in the polyphase configuration illustrated in FIG. 7. The direct conduction path utilized when the battery cell 102 has a sufficient charge state may be associated with extremely small voltage losses since the voltage drop across the diodes of the H bridge is extremely small (e.g., 0.7 V per diode) and the voltage drop of DC current across the series inductor is negligible. Similarly, in the asynchronous configuration described above where the full bridge rectifier in the secondary circuit 106 is replaced with an H bridge inverter circuit, the voltage losses may be very small and in some instances even lower since the voltage drop across a switching device can be lower than that of a diode.

In embodiments of the present invention, the output voltage of the DC-DC voltage converter apparatus can be regulated in a number of different ways. In some embodiments, the apparatus may operate in a “constant voltage” mode where a target voltage is established, and the output of the DC-DC converter circuit is fixed to be the difference between the target voltage and the battery cell voltage. In some embodiments, a “constant open-circuit voltage” mode is configured, such that the output voltage of the converter is dynamically generated to be the difference between the target voltage and the open-circuit battery cell voltage at its current state of charge. In this configuration, the size of the DC-DC converter may be further reduced as it need not compensate for voltage changes due to overpotentials and internal resistance. In some embodiments, another mode of operation can include fixing the output voltage of the DC-DC converter to zero until the battery cell voltage (either terminal or open-circuit) falls below a minimum value, at which point the voltage converter begins to contribute voltage to that provided by the battery cell 102 to the load device 108. In this configuration, the size of the converter may be even further reduced.

In some embodiments, the DC-DC voltage converter apparatus can be configured to utilize zero current switching (ZCS) and/or zero voltage switching (ZVS). Such modes of operation can further improve the efficiency of the primary and secondary circuits 104, 106, and any suitable ZCS and ZVS circuit configurations may be incorporated to facilitate these functionalities. For example, a circuit configuration provide phase shift switching may support ZVS operations.

In some embodiments, a cooling apparatus can be utilized to regulate the operating temperature of the DC-DC voltage converter apparatus. For example, a cold plate member incorporating liquid coolant can be coupled to the voltage converter, the liquid coolant removing thermal energy generated by the converter. Such a cooling apparatus can further improve the performance of the converter, and may ensure that the operating temperature does not exceed the maximum temperature the converter is capable of tolerating to remain operational.

IV. Methods of Regulating DC Current from a Battery Cell

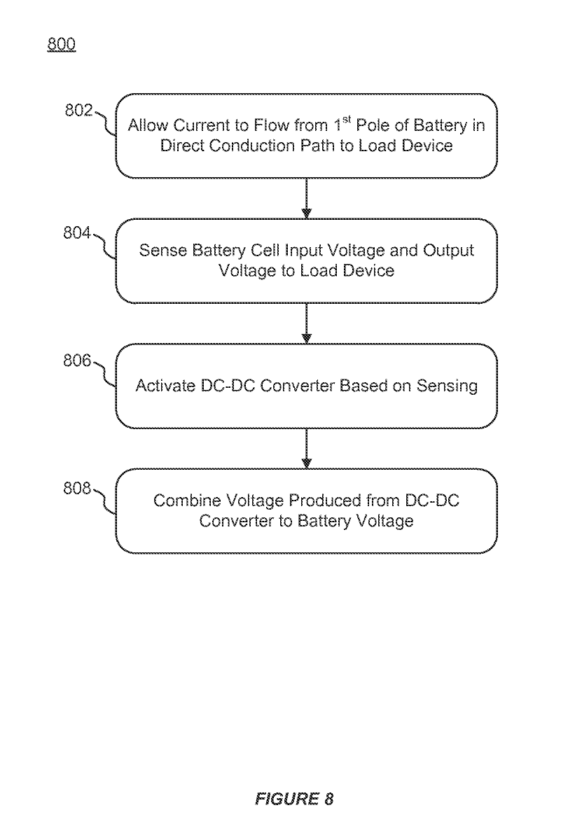

FIG. 8 illustrates an exemplary flowchart of a method 800 of regulating DC current from a battery cell, in accordance with some embodiments of the invention. The method 800 can be performed by any of the DC-DC voltage converter apparatus described above with reference to FIGS. 1-7, and may incorporate any of the functionalities described above as being associated with such voltage converter apparatuses.

At step 802, electrical current from a first pole of a battery cell can be allowed to flow in a direct conduction path through a circuit into a load device. For example, as described above, the circuit can include a primary circuit including an H bridge inverter circuit and a secondary circuit including a full bridge rectifier. In some embodiments, the direct conduction path can include diodes of the full bridge rectifier such that electrical current passes from the first pole of the battery cell through the diodes to the load device.

At step 804, a battery cell input voltage and an output voltage to the load device can be sensed during the current flow. As described above, a voltage sensor can be used to measure the voltage between a first and third node, the first node being coupled with the first pole of the battery cell and electrically connected with a first terminal of the load device, and the third node being electrically connected with a second terminal of the load device. In some embodiments, the voltage sensor can optionally measure the voltage between a second node and the third node, the second node being coupled with a second pole of the battery cell.

At step 806, a DC-DC converter can be activated from the battery cell based on the sensing. As described above, the DC-DC converter can include a primary circuit including an H bridge inverter circuit and a secondary circuit including a full bridge rectifier, the primary and secondary circuits being coupled to a primary winding and a secondary winding of a transformer, respectively, thereby forming a galvanically isolated energy transfer path between the primary and secondary circuits. Thus, in some embodiments, activating the DC-DC converter can include switching transistors in an H bridge configuration across a primary winding of a transformer, and rectifying voltage from a secondary winding of the transformer to produce the voltage produced by the DC-DC converter. In some embodiments, a time varying current waveform can be generated within a primary winding of the transformer, and the time varying current waveform from the a secondary winding of the transformer can be rectified to convert the time varying current waveform into the DC output.

At step 808, a voltage produced by from the DC-DC converter can be additively combined to a voltage from the battery cell during the current flow, the combined voltage powering the load device. As described above, the output of the secondary rectifying circuit of the DC-DC converter can be in series with the output of the battery cell, such that the voltage provided to the load device is the sum of the voltages produced by the voltage converter and the battery cell at the second node.

In some embodiments, the combined voltage powering the load device can have a range from about 300 V to 450 V. In some other embodiments, the combined voltage powering the load device can have a range from about 500 V to 700 V. In some other embodiments, the combined voltage powering the load device can have a range from about 600 V to 800 V. The combined voltage powering the load device can also be less than about 300 V and/or greater than about 800 V in some embodiments. The voltage produced from the DC-DC converter can be about 0 V to 500 V, 0 V to 450 V, 0 V to 400 V, 0 V to 350 V, 0 V to 300 V, 0 V to 250 V, or 0 V to 200 V. In some embodiments, the voltage produced from the DC-DC converter can be about 0 V to 150 V. Further, as described herein, the DC-DC voltage converter can be configured to subtract voltage from that provided by the battery cell. Accordingly, the exemplary voltages described above can be negative voltage values such that the combined voltage provided to the load device is lower than that provided by the battery cell alone.

The power provided to the load device can have a range from about 50 kW to 1 GW, 60 kW to 900 kW, 70 kW to 800 kW, 80 kW to 700 kW, or 90 kW to 600 kW peak power. In some embodiments, the power provided to the load device can have a range from about 100 kW to 500 kW peak power. Further, the DC-DC converter can use a switching frequency of about 1 kHz to 1 GHz, 2 kHz to 850 kHz, 3 kHz to 700 kHz, or 4 kHz to 550 kHz. In some embodiments, the DC-DC converter can use a switching frequency of about 5 kHz to 500 kHz.

Although the foregoing invention has been described in some detail by way of illustration and example for purposes of clarity of understanding, one of skill in the art will appreciate that certain changes and modifications can be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

What is claimed is:

1. A direct current (DC)-DC voltage converter apparatus for a wide voltage range battery cell, the apparatus comprising:
a first node configured to couple with a first pole of a battery cell and configured to electrically connect with a first pole of a load device;
a second node configured to couple with a second pole of the battery cell;
a third node configured to electrically connect with a second pole of the load device; and
a DC-DC voltage converter circuit comprising:
a primary circuit comprising a pair of terminals;
a secondary circuit comprising a pair of terminals and a direct conduction path for electrical current to pass from the second node to the third node; and
a galvanically isolated energy transfer path between the primary circuit and the secondary circuit,
wherein one terminal of the pair of terminals of the primary circuit is tied to the second node, the other terminal of the pair of terminals of the primary circuit is tied to the first node, one terminal of the pair of terminals of the secondary circuit is tied to the second node, and the other terminal of the pair of terminals of the secondary circuit is tied to the third node, such that a voltage output from the secondary circuit adds to voltage from the battery cell at the second node.

2. The apparatus of claim 1, wherein the battery cell includes a series-connected string of a plurality of battery cells.

3. The apparatus of any one of claims 1-2, wherein the primary circuit includes one or more switching devices.

4. The apparatus of claim 3, wherein the one or more switching devices are included in an H bridge inverter circuit.

5. The apparatus of claim 3, wherein the one or more switching devices are included in a polyphase inverter circuit.

6. The apparatus of any one of claims 3-5, wherein the galvanically isolated energy transfer path between the primary circuit and the secondary circuit includes a transformer.

7. The apparatus of claim 6, wherein the switching devices are coupled to a primary winding of the transformer.

8. The apparatus of claim 7, wherein the switching devices are configured to generate a time varying current waveform in the primary winding of the transformer.

9. The apparatus of claim 8, wherein the secondary circuit is coupled to a secondary winding of the transformer, and wherein the secondary circuit is configured to rectify a second time varying current waveform to convert the second time varying current waveform into a DC output.

10. The apparatus of any one of claims 6-9, wherein the transformer is a polyphase transformer.

11. The apparatus of any one of claims 3-10, further comprising:
a voltage sensor configured to measure a voltage between the first and third nodes;
an optional voltage sensor configured to measure a voltage between the second and third nodes; and
a control circuit configured to activate the switching devices based on the measured voltage between the first and third nodes, and optionally based on the voltage measured between the second and third nodes.

12. The apparatus of any one of claims 1-11, wherein the secondary circuit includes diodes configured in a full bridge rectifier.

13. The apparatus of any one of claims 1-11, wherein the secondary circuit includes diodes configured in a polyphase rectifier.

14. The apparatus of any one of claims 1-13, wherein the primary circuit includes a first H bridge inverter circuit and the secondary circuit includes a second H bridge inverter circuit.

15. The apparatus of anyone of claims 1-14, wherein the voltage converter circuit is configured for a battery string voltage range from about 150 V to 450 V, and is characterized by an output voltage range from about 300 V to 450 V.

16. The apparatus of any one of claim 1-15, wherein the voltage converter circuit is configured for a battery string voltage range from about 250 V to 750 V, and is characterized by an output voltage range from about 500 V to 700 V or from about 600 V to 800 V.

17. The apparatus of any one of claims 1-16, wherein the voltage added by the secondary circuit to the voltage from the battery cell at the second node is about 0 V to 150 V.

18. The apparatus of any one of claims 1-17, wherein the voltage converter circuit is characterized by an output power range from about 100 kW to 500 kW peak power.

19. The apparatus of any one of claims 1-18, wherein the voltage converter circuit is characterized by a switching frequency of about 5 kHz to 500 kHz.

20. The apparatus of any one of claims 1-19, wherein a dielectric material of the galvanically isolated energy transfer path is characterized by a breakdown voltage of about 600 V to 5 kV.

21. The apparatus as shown in any of FIGS. 1 to 7.

22. A method of regulating direct current (DC) from a battery cell, the method comprising:
allowing current from a first pole of a battery cell to flow in a direct conduction path through a circuit into a load device;
sensing a battery cell input voltage and an output voltage to the load device during the current flow;
activating a DC-DC converter from the battery cell based on the sensing; and
additively combining a voltage produced from the DC-DC converter to voltage from the battery cell during the current flow, the combined voltage powering the load device.

23. The method of claim 22, wherein the activating includes:
switching transistors in an H bridge configuration across a primary winding of a transformer; and
rectifying voltage from a secondary winding of the transformer to produce the voltage produced by the DC-DC converter.

24. The method of any one of claims 22-23, further comprising:
generating a time varying current waveform within a primary winding of a transformer; and
rectifying the time varying current waveform from a secondary winding of the transformer to convert the time varying current waveform into a DC output.

25. The method of any one of claims 22-24, wherein the combined voltage powering the load device has a range from about 300 V to 450 V, from about 500 V to 700 V, or from about 600 V to 800V.

26. The method of any one of claims 22-25, wherein the voltage produced from the DC-DC converter is about 0 V to about 150 V.

27. The method of any one of claims 22-26, wherein the power provided to the load device has a range from about 100 kW to 500 kW peak power.

28. The method of any one of claims 22-27, wherein the DC-DC converter uses a switching frequency of about 5 kHz to 500 kHz.
